(19) United States
(12) Patent Application Publication
(10) Pub. No.: US 2021/0185742 A1
(43) Pub. Date: Jun. 17, 2021

(54) MACHINE FOR PROCESSING FOODS AND PACKAGING PRODUCTS

(71) Applicant: KRONES AG, Neutraubling (DE)

(72) Inventors: Maximilian Hoferer, Regensburg (DE); Martin Wischinski, Regensburg (DE); Thomas Birkenseer, Lappersdorf (DE)

(21) Appl. No.: 16/338,976

(22) PCT Filed: Jul. 13, 2017
(86) PCT No.: PCT/EP2017/067724

§ 371 Date: Apr. 2, 2019

(30) Foreign Application Priority Data
Oct. 20, 2016 (DE) 10 2016 220 544.7

(51) Int. Cl. H04W 76/14; H04W 76/11; H04W 84/02; H04W 4/80

(52) U.S. Cl. CPC H04W 76/14; H04W 4/80; H04W 84/02; H04W 76/11

(57) ABSTRACT

A machine for processing foods and packaging products, including control elements for controlling components of the machine and an operating console for operating the machine by means of the control elements, wherein the operating console of the machine has an RFID-interface, in particular an NFC-interface, and is designed in such a way that an authentication of a user terminal is carried out by means of authentication data received via the RFID-interface, wherein the operating console is designed in such a way that it establishes a data connection in the event of a successful authentication.

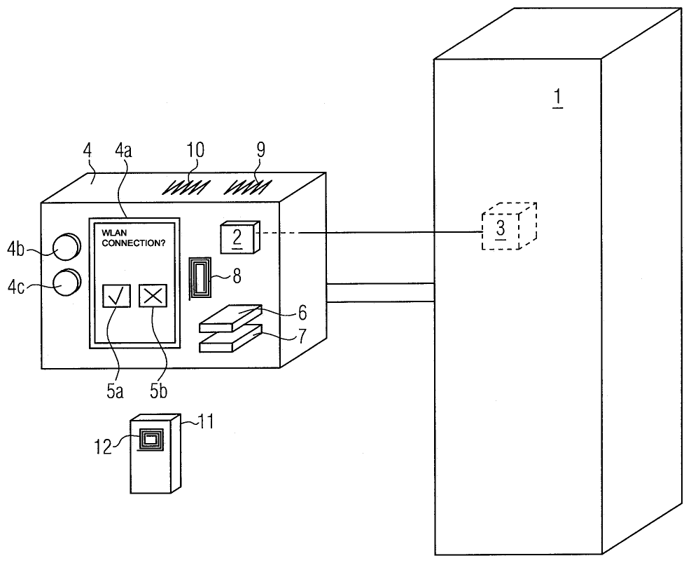

### CROSS-REFERENCE TO RELATED APPLICATIONS

The present application is the US national phase of International Application No. PCT/EP2017/067724, filed Jul. 13, 2017, which claims priority to German Patent Application No. 10 2016 220 544.7, filed Oct. 20, 2016. The priority application DE 10 2016 220 544.7 is hereby incorporated by reference.

### FIELD OF THE DISCLOSURE

The invention relates to a machine for processing foods and packaging products, comprising control elements for controlling components of the machine and an operating console for operating the machine by means of the control elements.

### BACKGROUND

In the food and packaging industry, it is customary for machines to be operated by user input into an operating console, particularly by specifying how control elements in operation control the components of the machine.

In practice, however, such operating consoles have various other functions. These include in particular that various information about the machine is recorded and stored. In particular, information for fault diagnosis or machine maintenance is often stored, for example, status data of the machine, a list of operating parameters used, a list of measured values detected during operation or the like. If necessary, an external storage medium, such as a USB stick, is usually connected to the operating console and this information is copied to the storage medium. The information can then be evaluated at a different location, often not at the customer, but at the manufacturer.

The procedure described above is comparatively cumbersome for the user. In addition, the known procedure can also be insecure, for example because it cannot be ruled out that a user is using a storage medium that is contaminated with viruses, or if data access is not subject to appropriate control.

### SUMMARY OF THE DISCLOSURE

It is therefore the object of the invention to provide a machine that enables data stored on an operating console to be transferred in a safe and less cumbersome way.

This problem is solved by the fact that the operating console of the machine has an RFID-interface, in particular an NFC-interface, and that it is configured in such a way that an authentication of a user terminal is carried out by means of authentication data received via the RFID-interface, wherein the operating console is configured in such a way that it establishes a data connection in the event of a successful authentication.

The data connections may include a wireless connection, such as WLAN or Bluetooth, and/or a wired connection, such as LAN.

For example, the user terminal may be a mobile phone, tablet or the like with an RFID interface, in particular NFC interface, and the authentication information may be stored on that terminal. Authentication information may include information that identifies the user terminal and/or its rights. If the user terminal is then within the range of the operating console's interface, the operating console can read the authentication information via the RFID interface and, if authorized, authenticate the user terminal and, upon successful authentication, establish a data connection that allows simple data transfer. The user does not have to take any action, he only has to carry the user terminal with him and be in the area of the operating console, especially within the range of the RFID antenna.

For example, the operating console can automatically dial into a specified network (such as a WLAN considered secure), select a partner device that is considered secure, or provide a protected network itself and only allow access to the network to devices that are considered secure. The above-mentioned configuration of the operating console thus enables access restriction or access control at least for establishing the data connection, but does not restrict the user, since no password entry or the like is required. In addition, access is only possible if the user is in the vicinity of the operating terminal, so that it is ensured that no third party gains unauthorized access in the absence of the authorized user. Furthermore, no potentially harmful data carriers are connected to the operating console.

Furthermore, access can take place here with a more or less arbitrary user terminal, for example a mobile phone, which can have various other functions. It is not necessary to provide specific devices, since an existing user terminal can simply be supplemented with the corresponding application. This allows the user terminal to be used for a variety of authentication applications and is not limited to authentication at the operating console only. RFID interfaces are based on RFID (Radio Frequency Identification) technology, which uses electromagnetic induction to communicate between two (typically frame) antennas. The interface includes hardware, such as the RFID antenna, and software components to communicate data via the antenna.

Preferably an HF-RFID (high frequency RFID) is used, which covers a frequency range of about 3 to 30 MHz, preferably between 10 and 20 MHz, preferably between 12 and 14 MHz Preferably, the frequency should be selected so that the range is approximately up to 1 m. The NFC (Near Field Communication) standard is an example of an HF-RFID standard where other standards or an industry standard-independent application are also possible. The NFC technology works in a frequency range of 13.56 MHz and has a range of about 10 cm. The advantage of the HF-RFID frequency range, especially the NFC standard, is that the range is user-friendly and at the same time can very reliably exclude unauthorized access.

It is also conceivable to use lower frequencies, particularly from the LF-RFID (low frequency RFID), which covers a frequency range from 30 kHz to 300 kHz and has a range of up to 10 cm, if this appears desirable in terms of range, susceptibility to interference and data rate. Frequencies above the HF-RFID range are suitable for applications where a long range (up to more than 10 m) is desired.

Preferably, however, frequencies should be selected where the range is between 5 cm and 1 m, in particular between 5 cm and 60 cm, in particular between 5 cm and 20 cm, in particular between 10 cm and 15 cm. In this way, the unintentional triggering of an authentication and, if necessary, the execution of automatically executable functions of the operating terminal can be avoided.

The operating console can be configured in such a way that a passive RFID operating mode is used as the default mode. In this operating mode, only one of the communicating RFID antennas, the active antenna, is powered. The other antenna uses energy from the electromagnetic field generated by the active antenna and responds by modulating the field of the active antenna.

In the present case, an RFID antenna on the operating console is powered in passive mode, but the antenna on the user terminal is not. In this case, for example, the operating console takes over the function of the reader, which reads information, such as authentication information, from the user terminal, which then takes over the function of the RFID tag. If no data is to be transferred from the operating console to the user terminal, this operating mode is advantageous because it is energy-saving and moreover because only the operating console consumes energy for communication, not the user terminal. This is advantageous, as the operating console is typically powered by power during normal operation, so that the additional energy consumption is easier to cope with than with battery-powered user terminals.

The operating console can be configured to check, for example at regular intervals, whether another RFID device is within range. This has the advantage that it is not necessary for the mobile user terminal to constantly search for suitable RFID partner devices, which costs energy, or for the user to activate the search, which makes the process more cumbersome for the user.

It is also possible to use by default an active operating mode in which the two RFID devices are powered, thus, enabling active transmission, or to switch to an active operating mode after authentication of a user terminal. This is advantageous if data exchange is to take place in both directions.

NFC technology has the particular advantage that the standard already provides that each NFC device can assume both an active and a passive function. In addition, many mobile devices, such as mobile phones or tablets, are already by default equipped with NFC interfaces.

The establishment of the data connection may include the establishment of one or more data connections with one or more other devices, in particular with the user terminal, and/or the provision of the or an, in particular access-protected, network and/or the login in the or an, in particular access-protected, network. The network can be a WLAN or LAN, for example.

For example, a direct connection, such as via Bluetooth, can be established between the operating console and a selected other device, via which data is then sent to this device. Alternatively or additionally, for example on the company premises, an access-protected network can be available to which the operating console can log in to establish the data connection. Via this network, data can then be sent to the Internet, to a server, or to another device that is logged in the network, for example.

Alternatively or additionally, the operating console may be configured to provide a network itself, such as a WLAN, and, after authentication of the user terminal via the RFID interface, it may automatically log in the user terminal to this network or transmit login information for this network to the user terminal. The user terminal can then log into the network using the login information. Alternatively or additionally, the operating console can be configured in such a way that it provides a network, for example WLAN, which is personalized, i.e. only available for a specific user terminal, and which is activated when the respective user terminal is authenticated. The user terminal can then, for example, be automatically logged in this network. Data can then be sent to the user terminal via the network provided by the operating console.

The operating console may have a WLAN function and/or a Bluetooth function and the data connection may be established via Bluetooth or WLAN.

As mentioned above, it has been common practice up to now to pass on information via an external data carrier connected to the operating console. However, this is very cumbersome. WLAN functions and Bluetooth functions have not yet been used, among other things, because permanent login to WLAN networks or permanently being visible as a Bluetooth device represents a security problem. Together with the above-mentioned authentication via the RFID interface, data can easily be transmitted via various interfaces, such as Bluetooth or WLAN, without taking the above-mentioned risks.

The operating console may be configured in such a way that one or more protected functions of the operating console are only accessible after successful authentication of the user terminal via the RFID interface. In particular, access to the protected functions may be denied if authentication is unsuccessful, for example, because there is no or no valid authentication information on the user terminal.

This means that selected functions are subject to access restrictions. These functions can only be performed if a user terminal that is within range of the operating console's RFID interface is successfully authenticated. However, the access restriction does not necessarily apply to all functions of the operating console. For example, access restrictions may include access to specific data, modifying data, copying data, moving data, logging in to networks, and/or establishing data connections, as explained in detail below. Functions related to machine control may also theoretically be protected functions. However, for safety reasons, some machine control functions should not be restricted in order to be able to respond quickly and independently of the user to machine malfunctions.

One, several, or all of the protected functions can be performed automatically upon successful authentication of the user terminal. This is advantageous because the user does not necessarily have to make cumbersome inputs, such as entering passwords or navigating to a menu and selecting which steps are to be carried out. In particular, all steps of a protected function can be performed automatically, for example, when connecting to a network, activating a network function, selecting a network and logging in to the network with a password. Automatic here means that a step (or function), if triggered, is executed without further user input. For example, the step can be triggered directly by authentication or as part of an automatic process, for example when a previous step has been completed, or by confirmation by the user.

The protected functions mentioned above may include activating communication functions such as the or a WLAN function and/or the or a Bluetooth function and/or establishing a data connection.

This means that there may be access restrictions for activating communication functions such as WLAN or Bluetooth and/or for establishing data connections to devices and networks. This is particularly desirable because an uncontrolled data connection to networks and devices can represent a security risk and should therefore only be activated by selected users.

In particular, any data used to establish one or more data connections with the other device(s) and/or to log in to an access-protected network, such as security keys or passwords, may be stored in a memory of the operating console, but access to such data and/or activation of the corresponding communication function may be protected functions. In this case, establishing one or more data connections with the other device(s) and/or logging in to the network can only be done after successful authentication by enabling the respective function.

The operating console may alternatively or additionally be configured such that it uses a first part of data received via the RFID interface for automatic login in to the or an access-protected network and/or sends login data for an access-protected network to the user terminal via the RFID interface, in particular for the or an access-protected network provided by the operating console. Automatic login is understood to mean that a user does not have to enter the data required for the login himself, but that the operating console takes over the first part of the received data for the login process. For example, an automatic login does not prevent the user from being requested to confirm that the login is to be performed.

The first part of the data received may include login data for the access-protected network, in particular a security key or password, and the operating console may be configured such that, upon authentication of the user terminal, automatic login is performed in the access-protected network using the login data. In addition to security keys, passwords or the like, the login data may also include an identification of the access-protected network to which the login data belongs.

This means that, in addition to authentication data for access to functions on the operating console, data can also be stored on the user terminal and transmitted to the operating console (via the RFID interface) that allow network access, such as security keys or passwords. This has the advantage of facilitating automatic connection to the network because the user does not need to enter any network keys or passwords. However, due to the limited range of RFID (see above), the process is still very secure.

The operating console may be configured to check whether data received via the RFID interface includes login data for an access-protected network, in particular by checking the type and/or format of the data and, if so, automatically searching for available networks and, if the login data includes valid login data for the available access-protected network(s), automatically performs login in to this network.

With these features it is enabled that no specific instructions have to be available to the operating console that or in which network it performs a login. It can detect by itself from the received data that the same contain login data and can then use these login data to perform a login attempt on available networks without sending a request to the user as to which network to choose.

The operating console can alternatively or additionally be configured in such a way that it determines (if possible) on the basis of the login data for which available access-protected network the login data is intended and initiates a login only in this access-protected network or that it initiates a login with the received login data in the available networks one after the other until the login in one of the available networks was successful.

In the first case, the correct network can be selected directly without sending user requests regarding the network to be selected, thus avoiding unnecessary login attempts. However, information that identifies the network must then be sent to the operating console. In the second case, no user requests are required and no information identifying the network needs to be sent. Failed login attempts may occur, but if there are only a few or even one network in range, this is usually not a problem.

The operating console may be configured such that it uses a second part of data received via the RFID interface to establish a data connection with another device.

Such connections with other devices can be Bluetooth connections, for example. In particular, a connection can be established with the user terminal itself. Bluetooth is advantageous because data transmission via Bluetooth typically has higher data transmission rates than NFC interfaces.

The operating console may be configured such that, upon authentication of a user terminal, it automatically searches for potential partner devices that allow the data connection to be established and/or makes the operating console visible to devices as a potential partner device. In particular, the operating console may be configured such that it automatically selects one or more partner devices from among the potential partner devices based on the data received via the RFID interface and automatically establishes a data connection with the selected partner device(s), in particular by automatically pairing with the selected partner device(s) via a Bluetooth interface. If the operating console is permanently visible, this may constitute a security risk. Automatic execution of the above steps is advantageous because manual pairing is often cumbersome, requires multiple attempts, and takes time.

The operating console can be configured such that it carries out several searches and/or connection attempts when establishing data connections, in particular Bluetooth connections, if no or no desired partner device is visible or if the connection attempt fails.

The operating console may be configured such that, prior to the automatic execution of one, more or all of the automatically executable steps, the user is requested to confirm that the respective step is to be carried out and the respective step is carried out only if the user confirms this, the confirmation being performed in particular at the operating console or at the user terminal. If the input is made via the user terminal, a data connection must be available to enable communication between the operating console and the user terminal in both directions.

The advantage of this is that the user has a certain influence on the steps taken, for example whether a data connection is established, instead of always carrying out these steps without user intervention during authentication. Nevertheless, the user does not have to carry out the steps manually, such as entering login data, because the steps themselves are still carried out automatically.

The confirmation request can be triggered by authentication and displayed on the operating console and/or the user terminal. For example, the user can enter a confirmation by pressing a control element, such as a key, mouse, or button on a touch display. In addition to the control element for confirmation, the user can also be shown a control element, such as a key or button on a touch display, to reject the available step(s).

The operating console may be configured such that the user can select, before any or all of the automatically executable steps are carried out, which of the available automatically executable steps is or are to be carried out, in particular wherein the selection takes place at the operating console or at the user terminal.

For this purpose, a list of the available automatically executable steps can be displayed on the user terminal or operating console, from which he can make the selection with a control element, for example a key, a mouse or a button on a touch display. In addition to the control to select steps that can be performed automatically, the user can also be shown a control element, such as a key or button on a touch display, to reject all suggested steps.

If the user confirms or selects an automatically executable step, this can trigger the execution of the step, which is then carried out automatically. If one or more steps are selected, an intermediate step can be carried out to confirm the selection and the automatic execution of the step can only be triggered after this confirmation.

After an automatically executable step has been triggered, for example, by the authentication itself or by the selection and/or confirmation by the user, the user no longer has to intervene (in normal operation), so the step is executed automatically. It is optionally possible for the user to be able to cancel or interrupt the step during automatic execution using a control element, such as a key, mouse or button on a touch display.

The invention also relates to a method for operating and/or maintaining a machine for processing food and packaging products, comprising control elements for controlling components of the machine and an operating console for operating the machine by means of the control elements, wherein the operating console of the machine comprises an RFID interface, in particular an NFC interface. When a user terminal approaches the RFID interface, authentication information is transmitted from the user terminal to the operating console via the RFID interface and authentication of the user terminal is carried out by means of the authentication information. Upon successful authentication, the operating console automatically establishes a data connection, for example via Bluetooth or WLAN, and transmits information about the machine, in particular information for fault diagnosis or machine maintenance, such as status data of the machine and/or a list of operating parameters used and/or a list of measured values detected during operation, to a network and/or to selected partner devices, in particular to the user terminal, via the data connection.

In particular, sending data to a network means sending data to one or more other devices connected to the network.

As described in connection with the device, the automatic establishment of the data connection can be triggered immediately and without user intervention by the successful authentication, but a user request can also be made before the automatic establishment of the data connection. For example, before a data connection is automatically established, the user may be requested for confirmation and/or selection of functions to be performed. The confirmation and/or selection can be made by the user at the operating console or at the user terminal. Preferably, however, it is done at the operating console because no additional data exchange between the operating console and the user terminal is required. Since the user is already close to the operating console for RFID communication, this is not a restriction.

The same applies to data transmission. This means that a function can be provided where the user confirms via the operating console that information about the machine is to be transmitted via the data link or selects which information about the machine is to be transmitted via the data link.

Authentication can enable access to login data and/or connection data already present on the operating console and/or the ability to automatically establish the data connection based on login data and/or connection data already present on the operating console. Alternatively or additionally, besides the authentication information, the operating console can also receive login and/or connection data from the user terminal via the RFID interface and automatically establish the data connection based on this data after authentication. Various possibilities for this have already been explained in detail in connection with the device and also apply here.

Alternatively or additionally, the operating console itself can provide a network, such as a WLAN, and after authentication of the user terminal, automatically log the user terminal in to this network or transmit login information for this network to the user terminal via the RFID interface. The user terminal can then log in to the network using the login information.

Alternatively or additionally, the operating console can provide a network, for example WLAN, which is personalized, thus, for example only available for a certain user end device, and which is activated when the respective user terminal is authenticated. For example, the user terminal can then immediately log in to the personalized network without the need to transmit additional login information. Data can then be sent to the user terminal via the network provided by the operating console.

It should be noted that in the passive operating mode described above in relation to the device, the authentication information and, where appropriate, the login and/or connection data can be read via the RFID interface of the operating console without the active involvement of the user terminal.

The features described in connection with the machine are also applicable to the method and the advantages mentioned there apply analogously to the corresponding method steps.

### BRIEF DESCRIPTION OF THE DRAWING

The FIGURE shows a schematic representation of an embodiment that is not true to scale.

### DETAILED DESCRIPTION OF THE PREFERRED EMBODIMENTS

The FIGURE shows in particular a machine 1 for processing food and packaging products, comprising control elements 2 for controlling components 3 shown here only schematically. The control elements can, for example, be computing units which are configured for controlling and/or regulating the components. These computing units can be integral with the operating console. The components can include electric motors, controllable valves or the like.

Furthermore, the operating console 4 for operating the machine by means of the control elements is shown here. The operating console comprises a display element and at least one input element. In this example, the display element is integral with an input element in the form of a touch display 4a. Two additional input elements are configured in the form of keys 4b and 4c. It is self-evident that a different number of input elements may be provided and that only one type of input element, for example only a touch display or only keys, may be provided.

The keys are control elements for the operating console. The FIGURE also shows buttons 5a and 5b on the touch display, which are also control elements for the operating console. These buttons can be displayed permanently during operation or only in particular situations, for example, when the user is requested for input, such as selection or confirmation.

The operating console also comprises a computing unit 6, that is only schematically indicated here, with which the functions of the operating console are implemented, and a memory 7, in which, for example, information about the machine is stored, in particular information for fault diagnosis or machine maintenance, such as for example status data of the machine and/or a list of operating parameters used and/or a list of measured values detected in operation.

The operating console also includes an RFID antenna 8, exemplarily an NFC antenna. In addition, the operating console includes a Bluetooth antenna 9 and a WLAN antenna 10, which are only schematically indicated, wherein they can be any known Bluetooth or WLAN antennas. The operating console can also include only the RFID antenna and no Bluetooth or WLAN antenna, or it can include the RFID antenna and only the Bluetooth or WLAN antenna. It should be noted that Bluetooth antennas typically operate in the range of UHF radio waves and WLAN antennas operate in the range of UHF radio waves or SHF radio waves, thus, in other frequency ranges than the NFC antenna.

The antennas each form part of a corresponding interface, that is, an RFID interface (in this example an NFC interface), Bluetooth interface, or WLAN interface, wherein the interface, as described above, also comprises the corresponding software components.

The RFID antenna is connected to a power supply and generates electromagnetic fields when electricity is supplied. By means of the RFID antenna, the operating console can communicate via electromagnetic induction with another RFID antenna located within range of the operating console's RFID antenna. If no power is supplied, it can be addressed by another active RFID antenna via electromagnetic fields generated by it.

This example shows an NFC interface with an NFC antenna. NFC antennas operate in a frequency range of 13.56 MHz and have a range of about 10 cm. In addition, NFC interfaces are configured to play both the active and passive role in communication with another NFC interface. The advantage of NFC interfaces is that they are standardized and thus compatibility of partner devices can be ensured more easily and they are often already present in mobile devices. They also have a suitable range for the application at hand. Alternatively, other RFID antennas can be used, especially with different frequency bands or ranges.

The FIGURE also shows a user terminal 11, which in this example is not part of the machine according to the invention. The user terminal here is a mobile communication device, for example a mobile phone or a tablet, and comprises an RIFD interface which is a suitable counterpart to the RFID interface of the machine, in this case also an NFC interface with an NFC antenna 12.

The operating console is configured to include the following functions: searching for NFC antennas within their range, reading or receiving and processing data concerning NFC antennas within range of the NFC interface of the operating console via the NFC interface, authenticating user terminals from which valid authentication information has been received via the NFC interface, connecting to networks and/or other devices via the WLAN and/or Bluetooth interfaces, enabling and disabling protected functions, accessing and transmitting data stored in the memory of the operating console.

Alternatively or additionally, the operating console can be configured such that it provides a network itself, for example a WLAN, and that after authentication of the user terminal, it automatically logs the user terminal in to the network or transmits login information for this network to the user terminal via the RFID interface. The user terminal can then log in to the network using the login information. Alternatively or additionally, the operating console can be configured such that it provides a network, for example WLAN, which is personalized, thus, for example only available for a certain user terminal, and which is activated when the respective user terminal is authenticated.

In addition, an optional function can be provided to display a request to the user on the operating console display element after successful authentication, for example, to confirm the execution of further steps or to select and possibly confirm available steps, and to proceed according to a corresponding user input via one or more of the operating elements, for example, to carry out certain steps automatically.

In the following, methods according to inventions are explained, which can be carried out, for example, with the machine described above or another machine according to invention.

The first example is a method by which the successful authentication of a user terminal automatically enables protected functions of the operating console. First a passive operating mode in which the operating console assumes the active role and the user terminal the passive role will be described here.

The operating console uses its NFC antenna to search for other NFC antennas within its range. This can be done periodically, for example. If a user terminal with an NFC antenna comes within the range of the NFC antenna of the operating console, it communicates with this antenna. In passive mode, the antenna of the user terminal is not supplied with power. The operating console's NFC antenna reads information from the user terminal's NFC antenna. Therefore, in the passive operating mode described here, the operating console is also referred to as the reader. This information includes authentication information that identifies the user terminal and/or its access rights. The operating console then determines whether the authentication information is valid, i.e. whether it meets the requirements for successful authentication. For example, in the simplest case, a list of permitted IDs can be stored in the operating console and the ID of the user terminal can be read out via the NFC interface. Authentication can be successful, if this ID exists in the list of permitted IDs. Various other authentication methods are also possible.

If authentication is not successful, the protected functions will not be enabled. Optionally, the user can be notified via the operating console, e.g. visually or acoustically.

If authentication is successful, the protected functions are immediately enabled without the user having to intervene. For example, a WLAN function or Bluetooth function or access to certain data can be enabled.

In particular, the method may comprise establishing a data connection, for example via the enabled WLAN or Bluetooth function. In this example, this is done without the user having to select or confirm it.

The fact that a data connection is established via the WLAN function, comprises here that the WLAN antenna is activated, that the operating console searches for available networks, and that login data for the network is used to log the operating console in to the network. These login data can be stored on the operating console or received in whole or in part via the NFC interface in addition to the authentication information. For example, data can be received via the NFC interface that specifies which network a connection is to be established with. Alternatively or additionally, network keys or passwords can be stored on the user terminal and read out via the NFC interface. The latter provides additional protection, since this data does not have to be stored on the operating console and it is not easy to gain unauthorized access to the login data via the operating console.

Alternatively or additionally, the operating console itself can provide a network, such as a WLAN, and after authentication of the user terminal, automatically log the user terminal in to the network or transmit login information for this network to the user terminal via the RFID interface. The user terminal can then log in to the network using the login information. Alternatively or additionally, the operating console can provide a network, for example WLAN, which is personalized, i.e. only available for a specific user terminal, and which is activated when the respective user terminal is authenticated. For example, the user terminal can then immediately log in to the personalized network without the need to transfer additional login information.

The entire procedure for establishing the data connection and the associated sub-steps are performed automatically. This means that the user does not have to make any inputs to log the operating console in to the network. For example, the user does not have to select the WLAN or enter the login data.

Alternatively, it is also possible that the individual sub-steps run automatically, however, that, for example, user requests still occur before some sub-steps. For example, after selecting the WLAN and after checking the availability of the corresponding login data, the operating console could a request the user for confirmation that a connection is actually to be established. Alternatively or additionally, the operating console could display a selection of available networks to the user and request him to select a network.

Typically, establishing a Bluetooth connection involves activating the Bluetooth antenna, making the operating console visible as an available Bluetooth device, searching for available partner devices, selecting an available partner device, and establishing a connection between the two devices. All these steps can be carried out without user intervention, similar to logging in to the wireless network. Alternatively, the user can be requested, for example, to confirm that the operating console is visible as a Bluetooth device and whether or to which device it should connect.

Insofar as such requests are intended, they are preferably made via a display element (e.g. the touch display described above) and the user confirms or selects via the input elements. For example, as explained above, the touch display may show buttons that allow the user to confirm or cancel the operation.

It should be noted that some of the steps described above to establish a connection may not depend on successful authentication. For example, a wireless antenna or Bluetooth antenna may be enabled by default and only the actual login to the WLAN or connection to the Bluetooth partner device may be enabled by authentication.

As described above, the function of accessing certain data may also be protected. In particular, this may involve information about the machine, in particular information for fault diagnosis or machine maintenance, such as machine status data and/or a list of operating parameters used and/or a list of measured values detected during operation, which is stored on the operating console.

A preferred further embodiment is a process in which, after successful authentication, a data connection is automatically established with a WLAN or a Bluetooth partner device, in particular the authenticated user terminal, that the data described above is automatically accessed and that it is sent to a selected device also logged in to the WLAN or to the connected Bluetooth partner device. It is particularly preferred that the individual steps and also the entire process run automatically, that is, the process is triggered by the successful authentication and runs completely without user input.

There are various ways to lock the protected functions after they have been enabled. It is possible that all protected functions are immediately locked as soon as the user terminal is no longer within the range of the NFC antenna of the operating console. Although this is particularly safe, it also has the consequence that running processes are unintentionally interrupted under certain circumstances. In addition, the user must then remain in the immediate vicinity of the operating console until the desired steps have been completed. It is therefore preferable that all protected functions are locked again after a specified period of time, after completion of a specified process, for example, the data transmission described above, or by user input, for example at the operating console. It is also possible that the locking of different protected functions is handled differently.

In a second example, it may be an active operating mode instead of the one described above. Then the user terminal and the operating console can exchange data in both directions via the NFC interface. For example, the operating console can signal to the user terminal that the authentication was successful and, if necessary, the user terminal can then transmit additional data to the operating console, such as login data for a network and/or instructions as to which steps the operating console is to carry out. The features described in connection with passive mode can also be applied to active mode.

It is possible that the passive operating mode is the default mode and is switched to the active mode when the user terminal signals this.

It is self-evident that the features mentioned in the embodiments described above are not limited to these special combinations and can also be used in any other combination.

What is claimed is:

1. A machine for processing foods and packaging products,
comprising control elements for controlling components of the machine and an operating console for operating the machine (1) by means of the control elements,
the operating console of the machine having an RFID-interface, and being configured in such a way that an authentication of a user terminal is carried out by means of authentication data received via the RFID-interface, wherein the operating console is configured in such a way that it establishes a data connection in the event of a successful authentication.

2. The machine according to claim 1, wherein the establishment of the data connection comprises at least one of a group including the establishment of one or more data connections with one or more other devices, the provision of an access-protected network, and a login in the access-protected network.

3. The machine according to claim 1, wherein the operating console has at least one of a WLAN function and/or or a Bluetooth function and the data connection is established via Bluetooth or WLAN.

4. The machine according to claim 1, wherein the operating console is configured in such a way that one or more protected functions of the operating console can only be accessed after successful authentication of the user terminal via the RFID interface, wherein one, several or all of the protected functions are carried out automatically upon successful authentication of the user terminal.

5. The machine according to claim 4, wherein the protected functions comprise at least one of a group including activating the WLAN function, activating the Bluetooth function, and establishing the data connection.

6. The machine according to claim 1, wherein the operating console is configured in such a way that it at least one of uses a first part of data received via the RFID interface for automatic login in an access-protected network, or sends login data for an access-protected network to the user terminal via the RFID interface.

7. The machine according to claim 1, wherein the first part of the received data comprises login data for the access-protected network, in particular a security key or a password, and wherein the operating console (4) is configured in such a way that, upon authentication of the user terminal (11), automatic login takes place in the access-protected network using the login data.

8. The machine according to claim 1, wherein the operating console is configured to check whether data received via the RFID interface comprises login data for a protected network, by checking at least one of the type or format of the data, and if this is the case, automatically searches for available networks, and if the login data are valid login data for an available, access-protected network, automatically performs a login in this network.

9. The machine according to claim 8, wherein the operating console is configured in such a way that it uses the login data to determine for which available access-protected network the login data is intended, and one of initiates a login only in this access-protected network, or initiates a login with the received login data in succession in the available networks, until the login was successful in one of the available networks.

10. The machine according to claim 1, wherein the operating console is configured in such a way that it uses a second part of data received via the RFID interface to establish a data connection with a further device.

11. The machine according to claim 10, wherein the operating console is configured in such a way that, upon authentication of a user terminal, it at least one of automatically searches for potential partner devices with which it is possible to establish the data connection or makes the operating console visible to devices as a potential partner device.

12. The machine according to claim 11, wherein the operating console is configured in such a way that, based on the data received via the RFID interface, it automatically selects one or more partner devices from the potential partner devices and automatically establishes a data connection with the selected partner device(s).

13. The machine according to claim 1, wherein the operating console is configured in such a way that, before the automatic execution of one, several or all of the automatically executable steps, the user is requested to confirm that the respective step is to be carried out, and the respective step is only carried out if the user confirms this, wherein the confirmation is carried out at the operating console or at the user terminal.

14. The machine according to claim 1, wherein the operating console is configured in such a way that the user can select, before any or all of the automatically executable steps are carried out, which of the available automatically executable steps is or are to be carried out, wherein the selection takes place one of at the operating console or at the user terminal.

15. A method for operating and maintaining a machine for processing foods and packaging products, including control elements for controlling components of the machine and an operating console for operating the machine by means of the control elements,
the operating console of the machine having an RFID-interface,
transmitting authentication information from the user terminal to the operating console via the RFID interface when a user terminal approaches the RFID interface, and authenticating the user terminal by means of the authentication information, and
the operating console, upon successful authentication, establishing a data connection, and, via the data connection, transmitting information about the machine to at least one of a network or selected partner devices.

16. The method according to claim 15, and in the operating console transmitting information about the machine to at least one of the network or selected partner devices, the information about the machine is for one of fault diagnosis or machine maintenance.
